(19) United States
(12) Patent Application Publication
(10) Pub. No.: US 2020/0241326 A1
(43) Pub. Date: Jul. 30, 2020

(54) SUNGLASSES ASSEMBLY HAVING SIMULATED MONOLITHIC LENS

(71) Applicant: TSAIR YUARN INDUSTRIAL CO., LTD., TAINAN CITY (TW)

(72) Inventor: PAO-MING HUANG, TAINAN CITY (TW)

(21) Appl. No.: 16/256,082

(22) Filed: Jan. 24, 2019

(51) Int. Cl. G02C 7/10; G02C 1/04; G02C 5/12

(52) U.S. Cl. CPC G02C 7/10; G02C 2200/08; G02C 5/12; G02C 1/04

(57) ABSTRACT

A sunglasses assembly having a simulated monolithic lens is disclosed herein. It comprises a main frame; a secondary frame disposed on the main frame and having an upper portion, a lower portion, two lateral portions connected two ends of the upper portion and the lower portion, a nose bridge portion at a middle thereof, two lenses assembly holes defined by the upper portion, the lower portion, the two lateral portions and the nose bridge portion, and two first convex ribs disposed at two inner edges defined by the upper portion, the lower portion and the two lateral portions; and a shaded optical lenses assembly having two shaded optical lenses connected to each other, wherein each of the two shaded optical lenses has a connecting segment at an inner side thereof, a recessed region on an inner surface thereof, and an engaging groove at an outer edge thereof.

### BACKGROUND OF THE INVENTION

### 1. Field of the Invention

This invention relates to a sunglasses assembly having a simulated monolithic lens assembled by two shaded optical lenses.

### 2. Description of Related Art

Vision correction optical lenses are mainly made of concave lenses or convex lenses, and the thickness of the optical lenses is determined by severity of myopia or hyperopia. A pair of well-covered sunglasses is usually equipped with excellent effects of eyes covering. In order to achieve well covering effects to fit a user's face, high bending-degree of the lenses surface are needed. However, the bending-degree of the optical lenses surface is usually low, and there are no sunglasses having monolithic optical lenses available on the market.

For instance, the Taiwan Pat. No. M381797 (U), issued on 1 Jun. 2010, has disclosed an eyeglass structure. It comprises a first sunglasses lenses shaped as a frame with two assembling holes thereon and second optical lenses with a vision correction function correspondingly engaged with assembling holes. Accordingly, the eyeglass structure provides glare-shielding effects and a clear sight at the same time by the first sunglasses lenses and the second optical lenses respectively. Although the eyeglass structure has advantages of providing various appearances by shaping the first sunglasses lenses, a junction of the first sunglasses lenses and the second optical lenses is obvious so that the integrity of the eyeglass structure is affected.

The Taiwan Pat. No. M315346 (U), issued on 11 Jul. 2007, has disclosed a glasses fixation structure having an auxiliary frame. It mainly comprises an auxiliary frame having an optical lenses mounted at an internal side of a main frame having sunglasses lenses. Accordingly, the auxiliary frame can be concealed by the sunglasses lenses and does not affect the overall appearance of this creation. However, this creation having an additional auxiliary frame mounted on the main frame increases the overall weight itself, which may cause uncomfortable when a user wears the creation.

Furthermore, the US Pat. No. 20180348540 A1, issued on 6 Dec. 2018, has disclosed a sunglasses having a simulated monolithic lens for improving the aforesaid disadvantages of the Taiwan Pat. Nos. M381797 (U) and M315346 (U). It comprises an assembly of shaded optical lenses, a frame and a nose pad. The shaded optical lenses assembly has two shaded optical lenses, and each of the two shaded optical lenses has a connecting segment on a side thereof for correspondingly connecting to each other and an insertion segment extended from the connecting segment. The nose pad has a slot to correspondingly engage with middle lower edges of the shaded optical lenses assembly and a socket disposed on the slot for tightly accommodating the two insertion segments so as to stably connect the two shaded optical lenses and to form the sunglasses having a simulated monolithic lens and a vision correction function.

### SUMMARY OF THE INVENTION

The present invention is aimed to provide a sunglasses assembly having a simulated monolithic lens assembled by two shaded optical lenses for improving the disadvantages of the Taiwan Pat. Nos. M381797 (U) and M315346 (U).

The sunglasses assembly having a simulated monolithic lens of this invention is achieved by the following technical features. It comprises: a secondary frame having an upper portion, a lower portion, two lateral portions for respectively connecting two ends of the upper portion and the lower portion, a nose bridge portion at a middle thereof, two lenses assembly holes defined by the upper portion, the lower portion, the two lateral portions and the nose bridge portion, and two first convex ribs disposed at two inner edges defined by the upper portion, the lower portion and the two lateral portions; a shaded optical lenses assembly having two shaded optical lenses, each of which has a connecting segment at an inner side thereof for correspondingly connecting to each other, a recessed region on an inner surface thereof, which faces a wearer's face, for correspondingly contacting the nose bridge portion, and an engaging groove at an outer edge thereof for correspondingly receiving each of the two first convex ribs; and a main frame having a frame body and a trough for engaging with the upper portion of the secondary frame for positioning. The trough is defined by an outer wall, an inner wall opposite to the outer wall, and a top wall. The top wall is connected at top ends of the outer wall and the inner wall.

Accordingly, the two shaded optical lenses are stably joined together to form a simulated monolithic lens, and the sunglasses assembly having a simulated monolithic lens has the function of vision correction.

According to an embodiment of this invention, the two first convex ribs can be changed to two trenches disposed at two inner edges defined by the upper portion, the lower portion and the two lateral portions, and the engaging grooves of the two shaded optical lenses can be changed to can be changed to two second convex ribs at outer edges of the two shaded optical lenses for correspondingly engaging with the two trenches so that the two shaded optical lenses can be assembled to the secondary frame.

According to an embodiment of this invention, the upper portion of the secondary frame is provided with a fixing hole, and the main frame is provided with an assembly slot corresponding to the fixing hole and a fixing member for inserting into the fixing hole and the assembly slot to position the secondary frame to the main frame.

According to an embodiment of this invention, the fixing hole is disposed at a middle of the upper portion of the secondary frame and above the nose bridge portion.

According to an embodiment of this invention, the two ends of the upper portion of the secondary frame are provided with two engaging blocks, and the main frame is provided with two slots for correspondingly engaging with the two engaging blocks. In such a case, the secondary frame is more firmly jointed to the main frame.

According to an embodiment of this invention, the main frame is provided with an engaging aperture penetrating the inner wall for communicating with the trough, a perforation extended upwards from a bottom of the inner wall for communicating with the engaging aperture, a pressing member correspondingly embedded in the engaging aperture and having a pressing portion, a connecting segment extended outwards from the pressing portion, an active positioning slot at a bottom of the connecting segment and corresponding to the perforation, an accommodating slot at an upper portion of the connecting segment, and two hooks respectively extended from two ends of the connecting segment, an elastic member correspondingly accommodated in the accommodating slot of the pressing member and having one end protruded from an opening of the accommodating slot for contacting an inner surface of the outer wall of the main frame, and a locating pin for inserting into the perforation of the main frame and the active positioning slot of the pressing member for positioning the pressing member in the engaging aperture. The secondary frame is provided with a concave slot for correspondingly insertion of the connecting segment of the pressing member and two orientation holes disposed at two sides of the concave slot and correspondingly hooked by the two hooks to fix the secondary frame to the main frame after the upper portion of the secondary frame is engaged with the trough of the main frame.

According to an embodiment of this invention, the frame body is further provided with a convex part on the outer wall thereof, in opposite to the elastic member, for positioning and limiting the one end of the elastic member.

The present invention has the following advantages. The shaded optical lenses assembly has effect of being a simulated monolithic lens by the recessed regions of the two shaded optical lenses contacting the nose bridge portion and the engaging grooves of the two shaded optical lenses engaging with the first convex ribs.

### BRIEF DESCRIPTION OF THE DRAWINGS

FIG. 1 is a front exploded view showing a first embodiment for a sunglasses assembly having a simulated monolithic lens according to the present invention;

FIG. 2 is a back exploded view showing the first embodiment for the sunglasses assembly having a simulated monolithic lens according to the present invention;

FIG. 3 is a partial stereogram showing a sunglasses assembly having a simulated monolithic lens according to the present invention;

FIG. 4 is a front view showing a sunglasses assembly having a simulated monolithic lens in assembly according to the present invention;

FIG. 5 is a partial cross-sectional view showing the first embodiment for the sunglasses assembly having a simulated monolithic lens in assembly according to the present invention;

FIG. 6 is a partial cross-sectional view showing a second embodiment for a sunglasses assembly having a simulated monolithic lens in assembly according to the present invention;

FIG. 7 is an exploded view showing a third embodiment for a sunglasses assembly having a simulated monolithic lens according to the present invention;

FIG. 8 is a lateral cross-sectional view showing the third embodiment for the sunglasses assembly having a simulated monolithic lens in assembly according to the present invention;

FIG. 9 is a top cross-sectional view showing the third embodiment for the sunglasses assembly having a simulated monolithic lens in assembly according to the present invention;

FIG. 10 is a top cross-sectional view showing a pressing member of the third embodiment pressed to detach a secondary frame from a main frame.

### DETAILED DESCRIPTION OF THE PREFERRED EMBODIMENT

In the following detailed description, for purposes of explanation, numerous specific details are set forth in order to provide a thorough understanding of the disclosed embodiments.

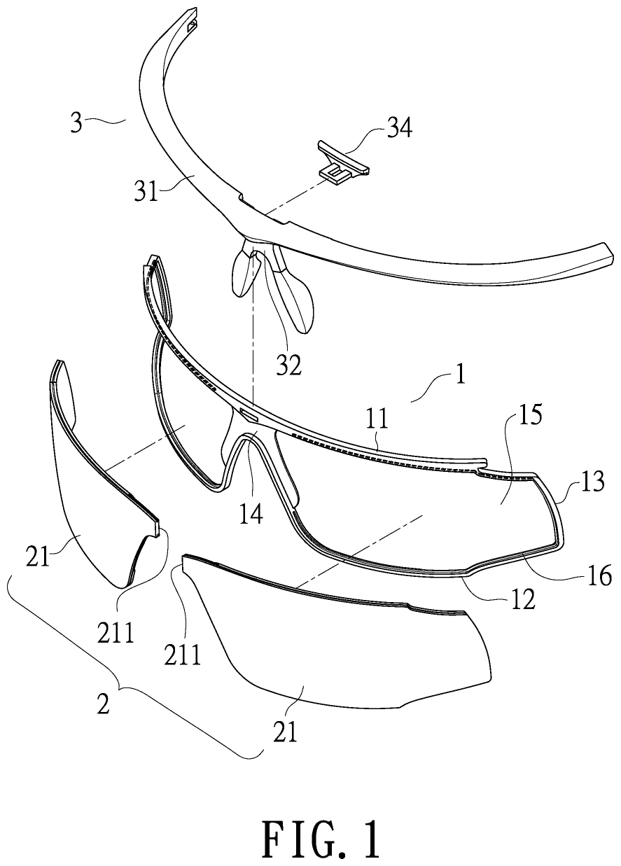

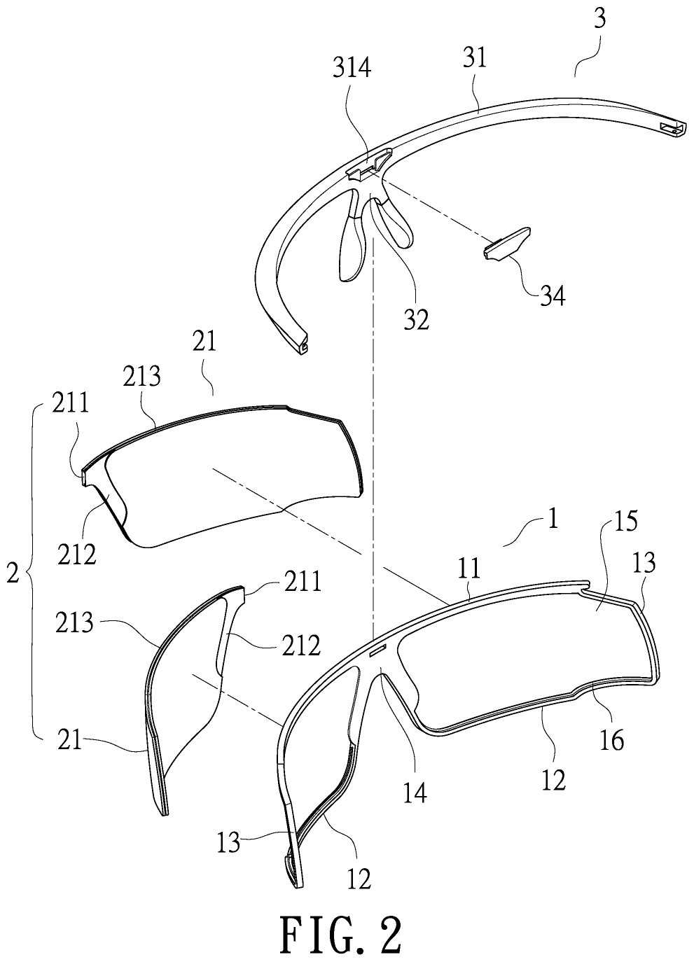

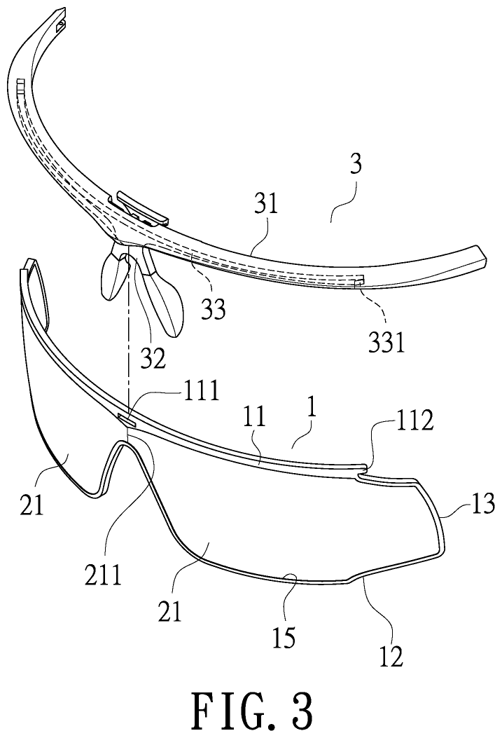

Referring to FIG. 1, FIG. 2 and FIG. 3, the term “outside” as used below refers to the side that is away from a wearer's face, whereas “inside” refers to the side that faces the wearer's face.

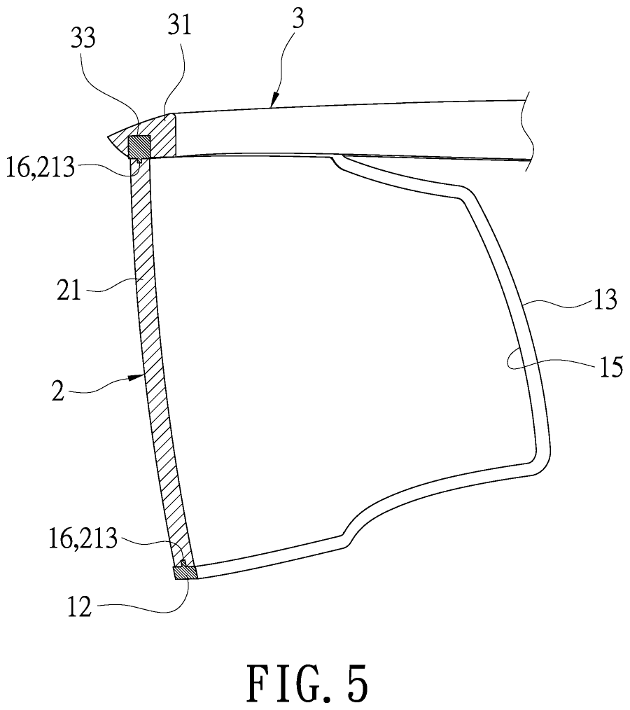

A sunglasses assembly having a simulated monolithic lens is disclosed herein. It comprises a secondary frame (1), a shaded optical lenses assembly (2) and a main frame (3). The secondary frame (1) has an upper portion (11), a lower portion (12), two lateral portions (13) for respectively connecting two ends of the upper portion (11) and the lower portion (12), a nose bridge portion (14) at a middle thereof, two lenses assembly holes (15) defined by the upper portion (11), the lower portion (12), the two lateral portions (13) and the nose bridge portion (14), and two first convex ribs (16) disposed at two inner edges defined by the upper portion (11), the lower portion (12) and the two lateral portions (13). The shaded optical lenses assembly (2) has two shaded optical lenses (21), each of which has a connecting segment (211) at an inner side thereof for correspondingly connecting to each other, a recessed region (212) on an inner surface thereof, which faces the wearer's face, for correspondingly contacting the nose bridge portion (14), and an engaging groove (213) at an outer edge thereof for correspondingly receiving each of the two first convex ribs (16) as shown in FIG. 5. The main frame (3) has a frame body (31), a nose pad (32) at a middle thereof, and a trough (33) for engaging with the upper portion (11) of the secondary frame (1) for positioning. The trough (33) is defined by an outer wall (311), an inner wall (312) opposite to the outer wall (311) and a top wall (313), and the top wall (313) is connected at top ends of the outer wall (311) and the inner wall (312).

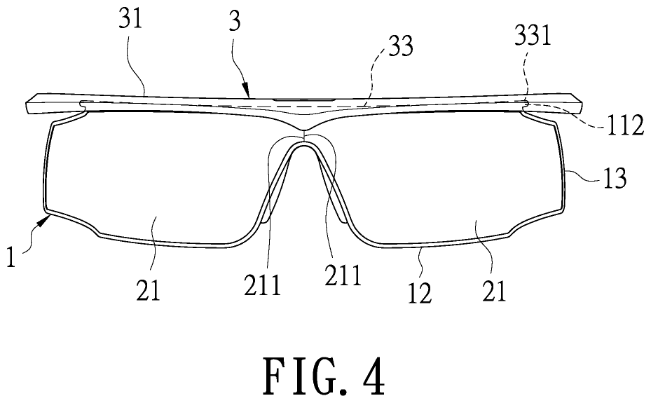

In assembling of the present invention, the engaging grooves (213) of the two shaded optical lenses (21) are correspondingly engaged with the two first convex ribs (16) of the secondary frame (1), and the recessed regions (212) of the two shaded optical lenses (21) are correspondingly in contact with the nose bridge portion (14) of the secondary frame (1). At the same time, the connecting segments (211) of the two shaded optical lenses (21) are connected to each other, so the shaded optical lenses assembly (2) is formed as a simulated monolithic lens. Then, the upper portion (11) of the secondary frame (1) is engaged with the trough (33) of the main frame (3) so that the secondary frame (1) is assembled to the main frame (3) to form the sunglasses assembly having a simulated monolithic lens and a vision correction function as shown in FIG. 4.

Furthermore, the nose bridge portion (14) disposed at the middle of the secondary frame (1) further limits a shape of the two lenses assembly holes (15) after molded to prevent the two lenses assembly holes (15) from being easily deformed by force and affecting the stability of the two shaded optical lenses (21) disposed in the two lenses assembly holes (15).

Referring to FIG. 1 to FIG. 4, the upper portion (11) of the secondary frame (1) is provided with a fixing hole (111), and the main frame (3) is provided with an assembly slot (314) on the frame body (31) corresponding to the fixing hole (111) and a fixing member (34) for inserting into the assembly slot (314) and the fixing hole (111) to position the secondary frame (1) to the main frame (3). Preferably, the fixing hole (111) is disposed at a middle of the upper portion (11) of the secondary frame (1) and above the nose bridge portion (14).

Additionally, in order to increase the stability of the connection of the secondary frame (1) and the main frame (3), the two ends of the upper portion (11) of the secondary frame (1) are provided with two engaging blocks (112), and the main frame (3) is provided with two slots (331) for correspondingly engaging with the two engaging blocks (112). In such a case, the engagement of the fixing member (34) near the nose bridge portion (14) and the engagement of the two engaging blocks (112) with the two slots (331) ensure the secondary frame (1) to stably connect the main frame (3).

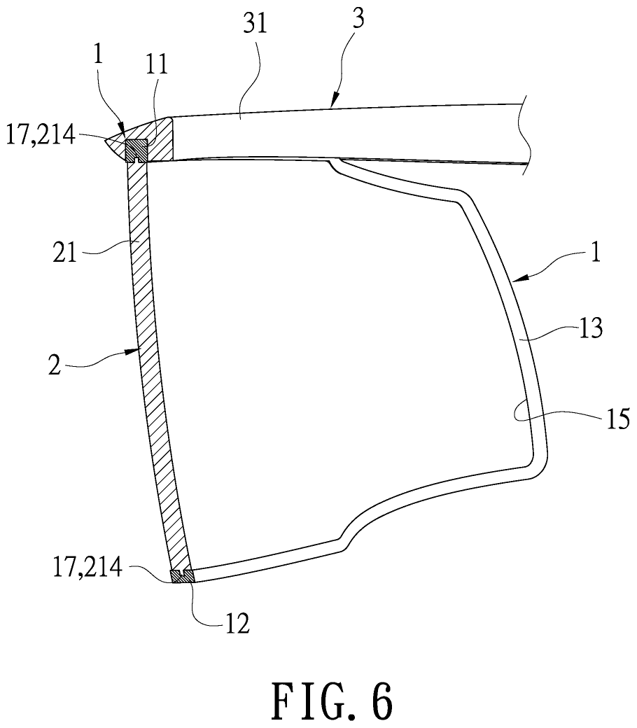

Referring to FIG. 6, a second embodiment for a sunglasses assembly having a simulated monolithic lens is disclosed. Two trenches (17) are disposed at two inner edges defined by the upper portion (11), the lower portion (12) and the two lateral portions (13), and two second convex ribs (214) are provided at outer edges of the two shaded optical lenses (21) for correspondingly engaging with the two trenches (17). Thus, the two shaded optical lenses (21) are assembled to the secondary frame (1).

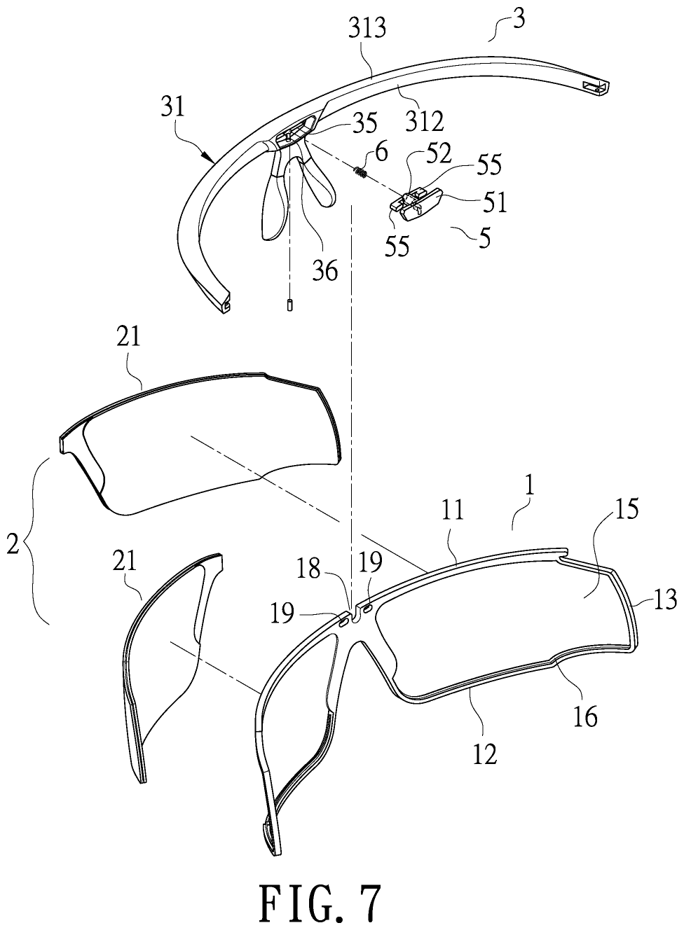

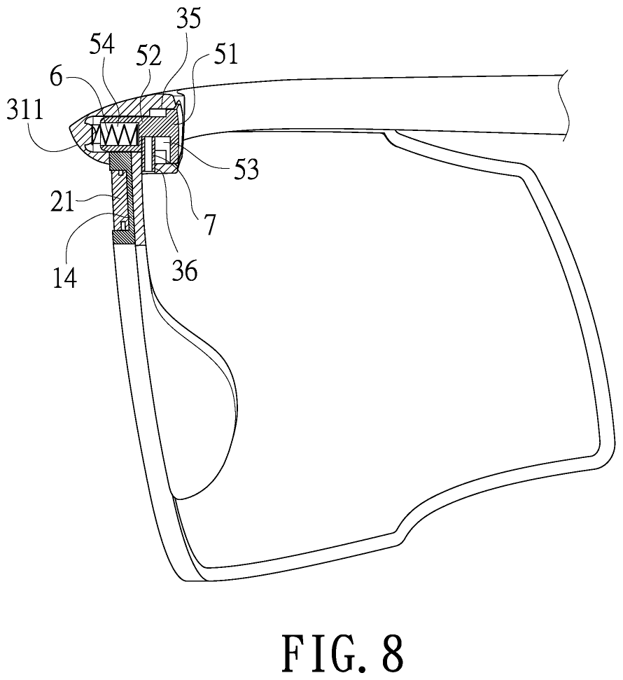

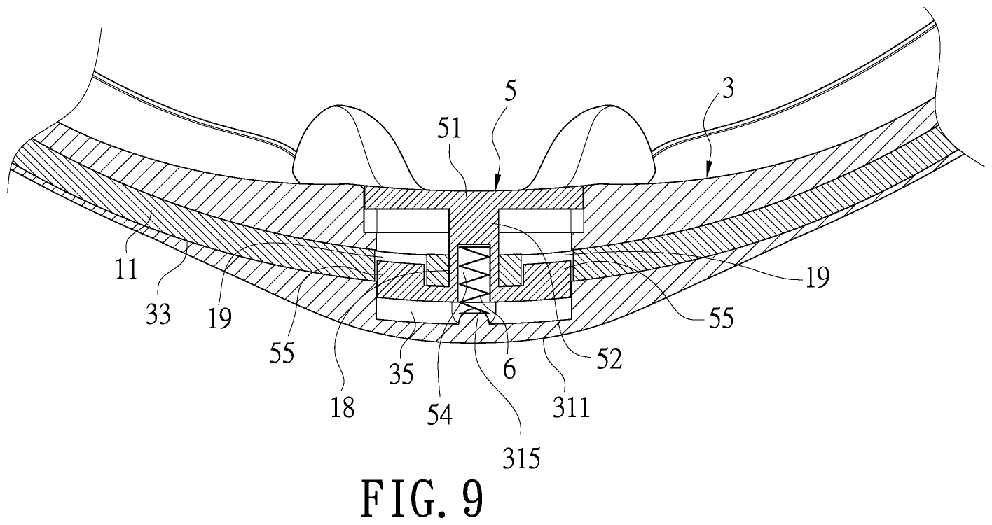

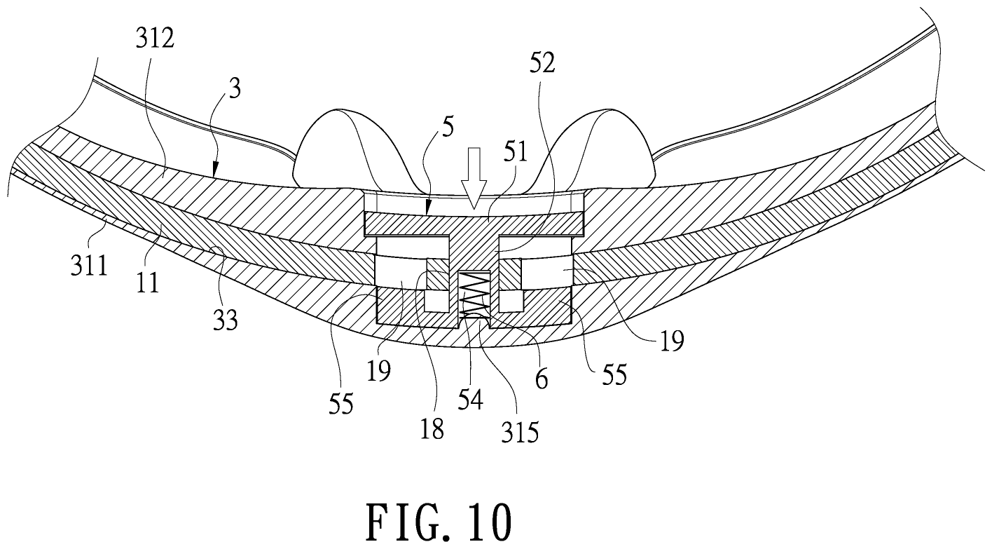

Referring to FIG. 7 to FIG. 10, a third embodiment for a sunglasses assembly having a simulated monolithic lens is disclosed. The main frame (3) is provided with an engaging aperture (35) penetrating the inner wall (312) for communicating with the trough (33), a perforation (36) extended upwards from a bottom of the inner wall (312) for communicating with the engaging aperture (35), a pressing member (5), an elastic member (6) and a locating pin (7). The pressing member (5) is correspondingly embedded in the engaging aperture (35) and provided with a pressing portion (51), a connecting segment (52) extended outwards from the pressing portion (51), an active positioning slot (53) at a bottom of the connecting segment (52) and corresponding to the perforation (36), an accommodating slot (54) at an upper portion of the connecting segment (52), and two hooks (55) respectively extended from two ends of the connecting segment (52). The elastic member (6) is correspondingly accommodated in the accommodating slot (54) of the pressing member (5), and one end of the elastic member (6) is protruded from an opening of the accommodating slot (54) for contacting an inner surface of the outer wall (311) of the main frame (3). The locating pin (7) is inserted into the perforation (36) of the main frame (3) and the active positioning slot (53) of the pressing member (5) for positioning the pressing member (5) in the engaging aperture (35). The secondary frame (1) is provided with a concave slot (18) for correspondingly insertion of the connecting segment (52) of the pressing member (5) and two orientation holes (19) disposed at two sides of the concave slot (18). After the upper portion (11) of the secondary frame (1) is engaged with the trough (33) of the main frame (3), the secondary frame (1) is fixed to the main frame (3) by the two hooks (55) hooking on the two orientation holes (19).

Additionally, the frame body (31) is further provided with a convex part (315) on the outer wall (311) thereof, in opposite to the elastic member (6), for positioning and limiting the one end of the elastic member (6).

In actual assembling the present invention, after the accommodating slot (54) of the pressing member (5) is embedded with the elastic member (6), the pressing member (5) is engaged in the engaging aperture (35) of the main frame (3) so that the elastic member (6) is positioned and limited by the convex part (315). Then, the locating pin (7) is inserted into the perforation (36) of the main frame (3) and the active positioning slot (53) of the pressing member (5) so as to position the pressing member (5) in the engaging aperture (35).

In assembling the lenses, after the pressing portion (51) of the pressing member (5) is pressed to compress the elastic member (6), the two hooks (55) of the pressing member (5) are displaced away from the path of the secondary frame (1) embedded in the trough (33) of the main frame (3). In such a case, the secondary frame (1) can be embedded in the trough (33) of the main frame (3). Furthermore, after the concave slot (18) of the secondary frame (1) is correspondingly engaged with the connecting segment (52) of the pressing member (5), the pressing member (5) is released and returned to an original position by an elastic restoring force of the elastic member (6), and the two hooks (55) are engaged with the two orientation holes (19) of the secondary frame (1) so as to achieve the effect of stably assembling the secondary frame (1) to the main frame (3).

The secondary frame (1) can be detached from the main frame (3) by pressing the pressing portion (51) of the pressing member (5) and releasing the two hooks (55) from the two orientation holes (19) of the secondary frame (1).

What is claimed is:

1. A sunglasses assembly having a simulated monolithic lens, comprising;
a secondary frame having an upper portion, a lower portion, two lateral portions for respectively connecting two ends of the upper portion and the lower portion, a nose bridge portion at a middle thereof, two lenses assembly holes defined by the upper portion, the lower portion, the two lateral portions and the nose bridge portion, and two first convex ribs disposed at two inner edges defined by the upper portion, the lower portion and the two lateral portions;
a shaded optical lenses assembly having two shaded optical lenses, each of which has a connecting segment at an inner side thereof for correspondingly connecting to each other, a recessed region on an inner surface thereof, which faces a wearer's face, for correspondingly contacting the nose bridge portion, and an engaging groove at an outer edge thereof for correspondingly receiving each of the two first convex ribs; and
a main frame having a frame body and a trough for engaging with the upper portion of the secondary frame for positioning, wherein the trough is defined by an outer wall, an inner wall opposite to the outer wall and a top wall, and wherein the top wall is connected at top ends of the outer wall and the inner wall.

2. The sunglasses assembly having a simulated monolithic lens of claim 1, wherein the upper portion of the secondary frame is provided with a fixing hole, and the main frame is provided with an assembly slot corresponding to the fixing hole and a fixing member for inserting into the fixing hole and the assembly slot to position the secondary frame to the main frame.

3. The sunglasses assembly having a simulated monolithic lens of claim 2, wherein the fixing hole is disposed at a middle of the upper portion of the secondary frame and above the nose bridge portion.

4. The sunglasses assembly having a simulated monolithic lens of claim 3, wherein the two ends of the upper portion of the secondary frame are provided with two engaging blocks, and the main frame is provided with two slots for correspondingly engaging with the two engaging blocks.

5. The sunglasses assembly having a simulated monolithic lens of claim 1, wherein the two ends of the upper portion of the secondary frame are provided with two engaging blocks, and the main frame is provided with two slots for correspondingly engaging with the two engaging blocks.

6. The sunglasses assembly having a simulated monolithic lens of claim 1, wherein the main frame is provided with an engaging aperture penetrating the inner wall for communicating with the trough, a perforation extended upwards from a bottom of the inner wall for communicating with the engaging aperture, a pressing member correspondingly embedded in the engaging aperture and having a pressing portion, a connecting segment extended outwards from the pressing portion, an active positioning slot at a bottom of the connecting segment and corresponding to the perforation, an accommodating slot at an upper portion of the connecting segment, and two hooks respectively extended from two ends of the connecting segment, an elastic member correspondingly accommodated in the accommodating slot of the pressing member and having one end protruded from an opening of the accommodating slot for contacting an inner surface of the outer wall of the main frame, and a locating pin for inserting into the perforation of the main frame and the active positioning slot of the pressing member for positioning the pressing member in the engaging aperture, and wherein the secondary frame is provided with a concave slot for correspondingly insertion of the connecting segment of the pressing member and two orientation holes disposed at two sides of the concave slot and correspondingly hooked by the two hooks to fix the secondary frame to the main frame after the upper portion of the secondary frame is engaged with the trough of the main frame.

7. The sunglasses assembly having a simulated monolithic lens of claim 6, wherein the frame body is further provided with a convex part on the outer wall thereof, in opposite to the elastic member, for positioning and limiting the one end of the elastic member.

8. A sunglasses assembly having a simulated monolithic lens, comprising;
a secondary frame having an upper portion, a lower portion, two lateral portions for respectively connecting two ends of the upper portion and the lower portion, a nose bridge portion at a middle thereof, two lenses assembly holes defined by the upper portion, the lower portion, the two lateral portions and the nose bridge portion, and two trenches disposed at two inner edges defined by the upper portion, the lower portion and the two lateral portions;
a shaded optical lenses assembly having two shaded optical lenses, each of which has a connecting segment at an inner side thereof for correspondingly connecting to each other, a recessed region on an inner surface thereof, which faces a wearer's face, for correspondingly contacting the nose bridge portion, and a second convex rib at an outer edge thereof for correspondingly engaging with each of the two trenches; and
a main frame having a frame body and a trough for engaging with the upper portion of the secondary frame for positioning, wherein the trough is defined by an outer wall, an inner wall opposite to the outer wall and a top wall, and wherein the top wall is connected at top ends of the outer wall and the inner wall.

9. The sunglasses assembly having a simulated monolithic lens of claim 8, wherein the upper portion of the secondary frame is provided with a fixing hole, and the main frame is provided with an assembly slot corresponding to the fixing hole and a fixing member for inserting into the fixing hole and the assembly slot to position the secondary frame to the main frame.

10. The sunglasses assembly having a simulated monolithic lens of claim 9, wherein the fixing hole is disposed at a middle of the upper portion of the secondary frame and above the nose bridge portion.

11. The sunglasses assembly having a simulated monolithic lens of claim 10, wherein the two ends of the upper portion of the secondary frame are provided with two engaging blocks, and the main frame is provided with two slots for correspondingly engaging with the two engaging blocks.

12. The sunglasses assembly having a simulated monolithic lens of claim 8, wherein the two ends of the upper portion of the secondary frame are provided with two engaging blocks, and the main frame is provided with two slots for correspondingly engaging with the two engaging blocks.

13. The sunglasses assembly having a simulated monolithic lens of claim 8, wherein the main frame is provided with an engaging aperture penetrating the inner wall for communicating with the trough, a perforation extended upwards from a bottom of the inner wall for communicating with the engaging aperture, a pressing member correspondingly embedded in the engaging aperture and having a pressing portion, a connecting segment extended outwards from the pressing portion, an active positioning slot at a bottom of the connecting segment and corresponding to the perforation, an accommodating slot at an upper portion of the connecting segment, and two hooks respectively extended from two ends of the connecting segment, an elastic member correspondingly accommodated in the accommodating slot of the pressing member and having one end protruded from an opening of the accommodating slot for contacting an inner surface of the outer wall of the main frame, and a locating pin for inserting into the perforation of the main frame and the active positioning slot of the pressing member for positioning the pressing member in the engaging aperture, and wherein the secondary frame is provided with a concave slot for correspondingly insertion of the connecting segment of the pressing member and two orientation holes disposed at two sides of the concave slot and correspondingly hooked by the two hooks to fix the secondary frame to the main frame after the upper portion of the secondary frame is engaged with the trough of the main frame.

14. The sunglasses assembly having a simulated monolithic lens of claim 13, wherein the frame body is further provided with a convex part on the outer wall thereof, in opposite to the elastic member, for positioning and limiting the one end of the elastic member.
